(19) United States
(12) Patent Application Publication
(10) Pub. No.: US 2024/0361926 A1
(43) Pub. Date: Oct. 31, 2024

(54) USING ENERGY CONSIDERATIONS TO DETERMINE PREFERRED AND NON-PREFERRED PATHS TO REDUNDANT STORAGE SYSTEMS HAVING A VOLUME

(71) Applicant: INTERNATIONAL BUSINESS MACHINES CORPORATION, Armonk, NY (US)

(72) Inventors: Imran Imtiaz, Manchester (GB); MILES MULHOLLAND, Eastleigh (GB); Anuj Chandra, Bengaluru (IN); Alastair Cooper, Winchester (GB)

(21) Appl. No.: 18/307,582

(22) Filed: Apr. 26, 2023

(51) Int. Cl. G06F 3/06

(52) U.S. Cl. CPC G06F 3/0625; G06F 3/0635; G06F 3/0679

(57) ABSTRACT

Provided are a computer program product, system, and method for using energy considerations to determine preferred and non-preferred paths to redundant first and second storage systems having a volume. A determination is made whether a first value of an energy attribute for the first storage system satisfies an energy criteria and whether a second value of the energy attribute for the second storage system satisfies the energy criteria. First paths to the first storage system are indicated as preferred and second paths to the second storage system are indicated as non-preferred in response to determining that the first value satisfies the energy criteria and the second value does not satisfy the energy criteria. The first paths are indicated as non-preferred and the second paths are indicated as preferred in response to determining that the first value does not satisfy the energy criteria and the second value satisfies the energy criteria.

### BACKGROUND OF THE INVENTION

### 1. Field of the Invention

The present invention relates to a computer program product, system, and method for using energy considerations to determine preferred and non-preferred paths to redundant storage systems having a volume.

### 2. Description of the Related Art

In a resilient storage environment, primary and secondary storage servers may maintain mirror copy relationships, where a primary volume in a mirror copy relationship comprises the storage or volumes from which data is physically copied to a secondary volume. Failover programs, such as International Business Machine Corporation's (“IBM”) HyperSwap®, which is a function in the z/OS® operating system, provides continuous availability for disk failures by maintaining the mirror copy relationships to provide synchronous copies of all primary disk volumes on one or more primary storage systems to one or more secondary storage systems. (HyperSwap and z/OS are registered trademarks of IBM in countries throughout the world). When a disk failure is detected, code in the operating system identifies managed volumes and instead of failing the I/O request, switches (or swaps) information in internal control blocks so that the I/O request is driven against the secondary volume of the mirror copy relationship. Since the secondary volume is an identical copy of the primary volume prior to the failure, the I/O request will succeed with no impact to the program issuing the I/O request, which could be an application program or part of the operating system. The failover to the secondary volume masks the disk failure from the program and avoids an application and/or system outage.

Asymmetric Logical Unit Access (ALUA) is a storage feature that allows for redundant paths to storage devices in redundant servers, such as in a HyperSwap or other SAN (Storage Area Network) environments, where multiple paths to storage devices are available for high availability and redundancy. ALUA performs load balancing and path failover in case of path failures. In certain cases, ALUA may select a preferred path to one of the redundant storage systems that is optimized for performance and expected to have the lowest latency. The higher latency path to the same volume in the other storage system is indicated as non-preferred.

There is a need in the art for improved techniques for indicating preferred and non-preferred paths to redundant storage systems to access a volume stored in the redundant storage systems.

### SUMMARY

Provided are a computer program product, system, and method for using energy considerations to determine preferred and non-preferred paths to redundant first and second storage systems having a volume. A determination is made whether a first value of an energy attribute for the first storage system satisfies an energy criteria and whether a second value of the energy attribute for the second storage system satisfies the energy criteria. First paths to the first storage system are indicated as preferred and second paths to the second storage system are indicated as non-preferred in response to determining that the first value satisfies the energy criteria and the second value does not satisfy the energy criteria. The first paths are indicated as non-preferred and the second paths are indicated as preferred in response to determining that the first value does not satisfy the energy criteria and the second value satisfies the energy criteria.

### BRIEF DESCRIPTION OF THE DRAWINGS

FIG. 1 illustrates an embodiment of a storage environment having redundant storage systems.

FIG. 2 illustrates an embodiment of a storage system.

FIG. 3 illustrates an embodiment of port group information.

FIG. 4 illustrates an embodiment of volume tiering information on storage devices in the storage systems.

FIG. 5 illustrates an embodiment of path performance and energy information.

FIG. 6 illustrates an embodiment of operations to configure volumes in redundant storage systems in a failover/failback system.

FIGS. 7a and 7b illustrate an embodiment of operations to determine a preferred path to redundant storage systems using energy attributes of the storage systems.

FIG. 8 illustrates an embodiment of a computer architecture used with described embodiments.

### DETAILED DESCRIPTION

Current Asymmetric Logical Unit Access (ALUA) technology optimizes based on preferred site and locking considerations, which means that high latency paths are non-preferred. However, such techniques for path selection that focus solely on latency may ignore other important considerations, such as energy related considerations. For instance, there is heightened concern about computing impacts on carbon output and climate change and the need to use renewable energy sources for computing. Other energy considerations to consider include the cooling capacity at data centers housing the storage systems. If one data center has limited available cooling capacity, than a path may be preferred that connects to a storage system in a data center having sufficient available cooling capacity over a data center having cooling capacity reaching saturation, where the data center has a greater risk of overheating.

Described embodiments provide improvements to computer technology for selecting paths to redundant storage systems as preferred and non-preferred based on important energy attributes, including reliance on renewable energy sources, available cooling capacity, and power costs of storage devices in the redundant storage systems in which the volumes to access are implemented.

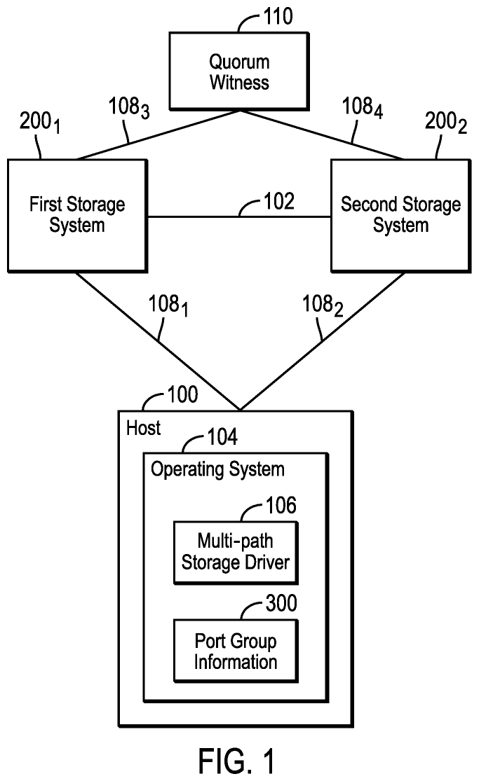

FIG. 1 illustrates a redundant storage environment having one or more host systems 100, one is shown, that accesses a volume, a copy of which is maintained at both a first storage system 200₁ and a second storage system 200₂. Writes are replicated between the volumes at the first storage system 200₁ and the second storage system 200₂ over a mirroring path 102, providing synchronous replication of writes, to allow the host to retrieve data for a volume from either the first 200₁ or the second storage system 200₂. The host 100 includes an operating system 104 having a multi-path storage driver 106 that allows multiple paths 108₁ and 108₂ to a storage volume at the first 200₁ and the second 200₂ storage systems, respectively. The multi-path storage driver 106 may implement Asymmetric Logical Unit Access (ALUA), that provides target port groups having status information for ports that define paths to the storage systems 200₁, 200₂. Paths 108₁, 108₂ defined by a target port group (TPG) of one of the first 200₁ or second 200₂ system is indicated as preferred and a target port group of the other storage system 200₂ or 200₁ is indicated as non-preferred. The host 100 maintains port group information 300, supplied by the storage systems 200₁, 200₂, on paths that indicates path status, such as preferred or non-preferred, also known as optimized or non-optimized. Additional states include standby, transitioning, and others.

Multiple hosts 100 may access data in the storage systems 200₁, 200₂ and more than two storage systems may provide redundant volumes.

In failover/failback embodiments, a volume may exist simultaneously at both the first 200₁ and the second 200₂ storage systems. The storage system 200₁, 200₂ target port group (TPG) indicated as preferred may comprise a primary storage system and the storage system target port group (TPG) indicated as non-preferred may comprise a secondary storage system.

The storage systems 200₁, 200₂ may implement a failover system where if one system fails, reads and writes may be directed to the other surviving storage system. To allow for failover, a quorum witness system 110 may monitor the health of both storage systems 200₁ and 200₂ over paths 108₃, 108₄ to arbitrate which storage system owns the primary volume and the secondary volume.

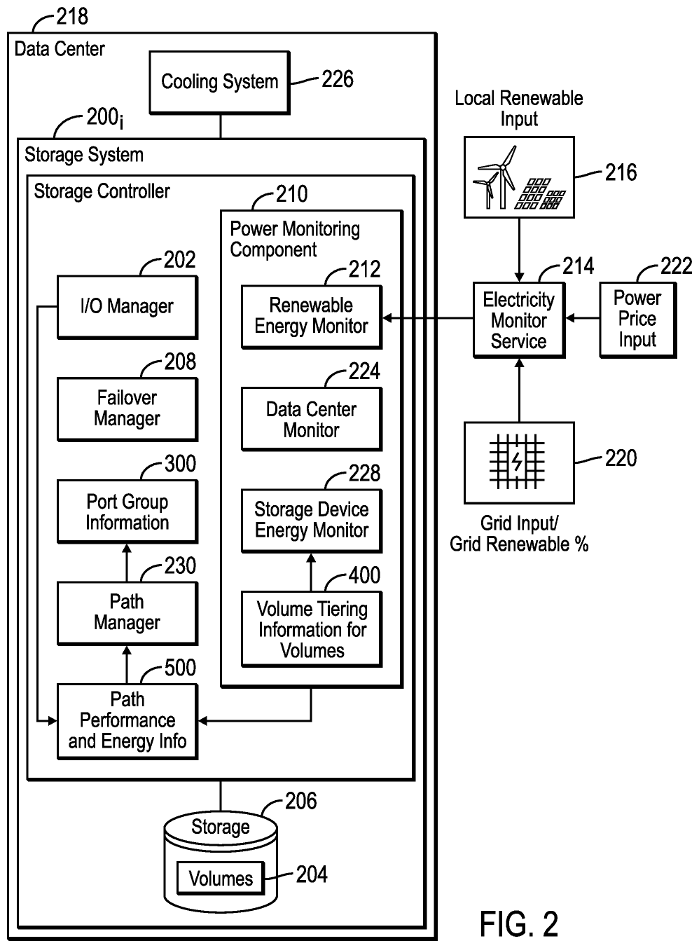

FIG. 2 illustrates an embodiment of a storage system 200ᵢ, such as storage systems 200₁ and 200₂, and includes, without limitation, an Input/Output (I/O) manager 202 to manage read and write requests from connected hosts 100 to storage volumes 204 implemented in a storage 206 comprised of storage devices, and to manage replication of writes to other storage systems 200j in a failover/failback relationship; a failover manager 208 to manage failover to another storage system 200ⱼ if there is a failure; a power monitoring component 210 including a renewable energy monitor 212 to receive information from an electricity monitor service 214 on local renewable energy input 216 to a data center 218 including the storage system 200ᵢ, information from a local power grid 220 indicating an extent to which the power grid supplying power to the data center 218 is using renewable energy, and information on power price input 222; a data center monitor 224 to receive information from the cooling system 226 at the data center 218 of available cooling capacity at the data center 218, such as available cooling capacity at a Heating, Ventilation, and Air Conditioning (HVAC) system; a storage device energy monitor 228 to determine a power cost of the storage devices comprising the storage 206 storing the volumes 204 based on volume tiering information 400; path performance and energy information 500 updated by the power monitoring component 210 to indicate the gathered energy related information; a path manager 230, such as an Asymmetric Logical Unit Access (ALUA) component, to determine which paths are preferred or non-preferred based on the path performance and energy information 500; and port group information 300 updated by the path manager 230 to indicate ports on the different storage systems 200₁, 200₂ organized in target port groups (TPG) and the status of the ports implementing the paths 108₁, 108₂, such as preferred or non-preferred.

The arrows shown in FIG. 2 between the processing elements and objects represent a data flow between the processing elements.

The volumes 204 may comprise a Logical Unit Number (LUN), Logical Subsystem (LSS), or any grouping of data units, such as tracks, Logical Block Address (LBA), storage cell, group of cells (e.g., column, row or array of cells), sector, segment, etc., which may be part of a larger grouping of tracks, such as a volume, logical device, etc.

For replication, initially, hosts 100 may direct Input/Output (I/O) requests to a designated primary storage system 200₁ to access data. In such case, the primary storage system 200₁ copies all volumes 204 being replicated to the secondary storage system 200₂ and then upon receiving an update to a volume 106a, transfers that updated data to the secondary storage system 200₂. In the event the primary storage system 200₁ is taken offline, due to a planned or unplanned event, a failover operation may be performed by the failover managers 208₁, 208₂ to failover from the primary storage system 200₁ to the storage system 200₂ so that all host 100 I/O access is redirected to the secondary storage system 200₂. The failover managers 208₁, 208₂ may also manage a failback operation, so that once the primary storage system 200₁ is back online, the failover managers 208₁, 208₂ may manage a failback from the secondary storage system 200₂ to the primary storage system 200₁ so that all host 100 I/O access is redirected back to the primary storage system 200₁. In certain embodiments, the failover manager 208₁, 208₂ may comprise International Business Machine Corporation's (“IBM”) HyperSwap® program or other similar failover programs by other vendors.

A failover operation from one server to another comprises any operation which redirects host 100 access from one storage system to another and provide hosts 100 continual access to data. In this way, the failover operation allows for continued, minimally interrupted access to storage.

The storage systems 200₁, 200₂ may each comprise an enterprise storage controller/server suitable for managing access to attached storage devices, such as, but not limited to, the International Business Machines Corporation's (“IBM”) DS8000® storage system or other vendor storage servers known in the art. (DS8000 is a registered trademark of IBM in countries throughout the world). The host operating system 104 may comprise an operating system such as Z Systems Operating System (Z/OS®) from International Business Machines Corporation (“IBM”) or other operating systems known in the art. (Z/OS is a registered trademark of IBM throughout the world).

The host operating system 104, multi-path storage driver 106, quorum witness 110, I/O manager 202, failover manager 208, power monitoring component 210, renewable energy monitor 212, data center monitor 224, storage device energy monitor 228, and path manager 230 may comprise program code loaded into the memory 112 and executed by one or more of the processors 110. Alternatively, some or all of the functions may be implemented as microcode or firmware in hardware devices in the host 100, storage system 200ᵢ, and quorum witness 110, such as in Application Specific Integrated Circuits (ASICs).

The storage 206 may comprise one or more storage devices known in the art, such as a solid state storage device (SSD) comprised of solid state electronics, NAND storage cells, EEPROM (Electrically Erasable Programmable Read-Only Memory), flash memory, flash disk, Random Access Memory (RAM) drive, storage-class memory (SCM), Phase Change Memory (PCM), resistive random access memory (RRAM), spin transfer torque memory (STM-RAM), conductive bridging RAM (CBRAM), magnetic hard disk drive (HDD), optical disk, tape, etc. The storage devices in the storage 206 may further be configured into an array of devices, such as Just a Bunch of Disks (JBOD), Direct Access Storage Device (DASD), Redundant Array of Independent Disks (RAID) array, virtualization device, etc. Further, the storage devices may comprise heterogeneous storage devices from different vendors or from the same vendor.

The paths 102, 108₁, 108₂, 108₃, 108₄ may be implemented in one or more networks, comprising as a Storage Area Network (SAN), a Local Area Network (LAN), a Wide Area Network (WAN), a Fibre Channel network, the Internet, and Intranet, a Peripheral Component Interconnect (PCI) bus interface, etc.

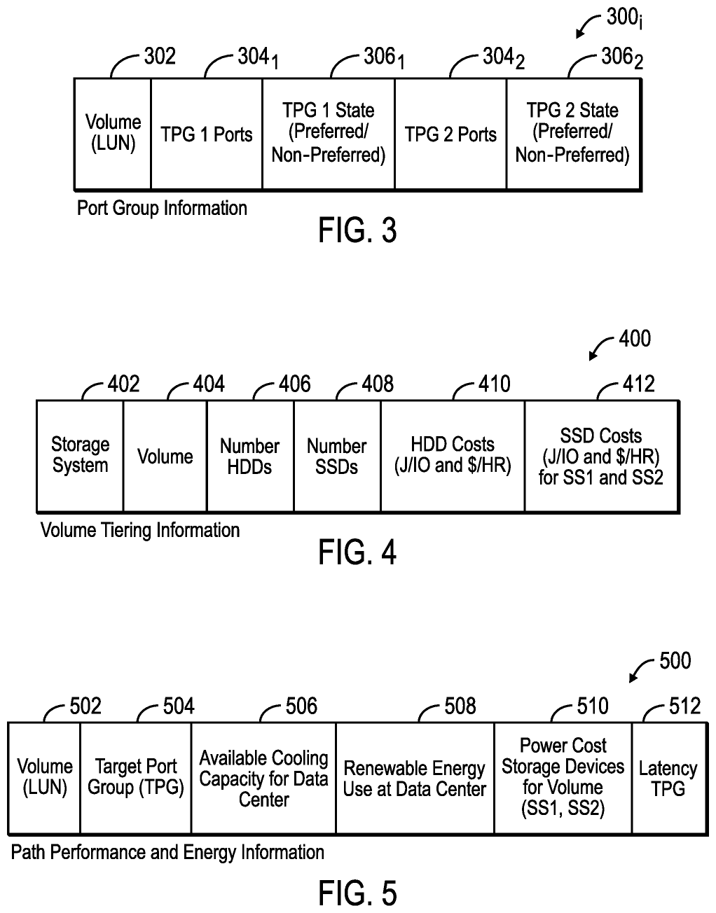

FIG. 3 illustrates port group information 300ᵢ for a volume 302 and for each storage system 200₁, 200₂, a target port group (TPG) 304₁, 304₂ providing information on ports on the storage system 200₁, 200₂ defining paths to the storage system 200₁, 200₂. Target port group (TPG) state information 306₁, 306₂ is provided for each target port group 304₁, 304₂ to indicate the status of each port/path in the target port group 304₁, 304₂ for the storage systems 200₁, 200₂. The state may indicate preferred or a non-preferred path. Examples of other states that may be indicated for the path groups 304₁, 304₂ include active preferred, active non-preferred, standby, inactive.

In FIG. 3, the state is provided at the TPG level for all ports on a storage system. In further embodiments, state information can be provided at the port level if ports in one TPG have different states. Although path state information is described as being implemented in target path groups, other data structures and formats may be used to provide information on paths to a storage system and the status of those paths.

FIG. 4 illustrates an embodiment of storage system volume tiering information 400 providing information on the type of storage devices in the storage 206 for a volume, and includes: a storage system 402; a volume 404; a number of hard disk drives (HDDs) 406 and a number of solid state drives (SSDs) 408 in which the volume 404 is implemented; HDD costs 410 and SSD costs 412, where the costs for the HDDs 410 and SSDs 412, respectively, may be expressed in terms of energy cost or Jules (J) per I/O operation and dollar cost per hour.

FIG. 5 illustrates an embodiment of path performance and energy information 500 providing the gathered energy related information for a volume 502 and target port group 504, and may include, without limitation, available cooling capacity 506 at the data scenter 218 in which the target port group 504 is included; renewable energy use 508 at the data center 218 including the target port group 504; power cost of storage devices 510 implementing the volume 502; and a latency 512 of the paths to the ports of the TPG.

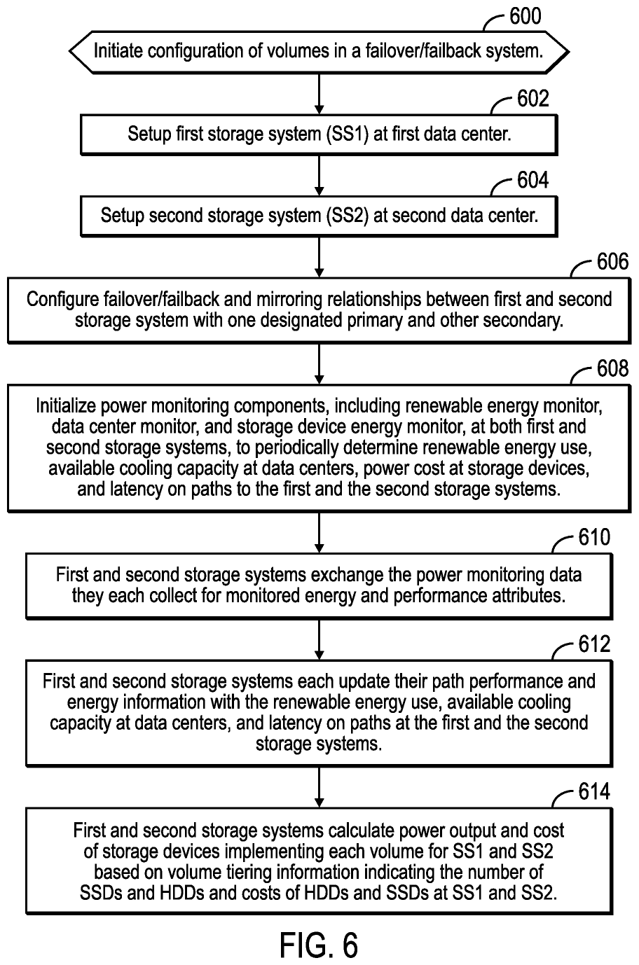

FIG. 6 illustrates an embodiment of operations performed by components in the storage systems 200₁, 200₂ to configure a failback/failover relationship between the storage systems 200₁, 200₂. To initiate (at block 600) configuration of volumes in a failover/failback system, such as IBM HyperSwap, the host 100 or storage systems 200₁, 200₂ may setup (at block 602) a first storage system 200₁ (SS1) in a first data center (DC1) 218₁ and setup (at block 604) a second storage system 200₂ in a second data center 218₂ (DC2). Failover/failback and mirroring relationships are configured (at block 606) between the first 200₁ and second 200₂ storage systems, with one designated as primary and the other secondary. The power monitoring components 210, including renewable energy monitor 212, data center monitor 224, and storage device energy monitor 228, at both the first 200₁ and second 200₂ storage systems, are initialized (at block 608) to periodically determine renewable energy use 508, available cooling capacity at data centers 506, power cost at storage devices 510, and latency 512 on paths to the first 200₁ and the second 200₂ storage systems.

The first 200₁ and the second 200₂ storage systems exchange (at block 610) the path performance and energy information 500 they each collect of values for monitored energy and performance attributes. The first 200₁ and second 200₂ storage systems each update (at block 612) their path performance and energy information 500 with the renewable energy use 508, available cooling capacity at data centers 506, and latency 512 on paths for the TPGs 504 at the first 200₁ and the second 200₂ storage systems. The first 200₁ and second 200₂ storage systems, e.g., storage device energy monitor 228 in the systems, each calculate (at block 614) power output cost of storage devices 510 implementing the volume 502 for the first 200₁ and the second 200₂ storage systems based on volume tiering information 400 indicating the number of HDDs 406 and SSDs 408 and costs of HDDs 410 and SSDs 412 at the storage systems.

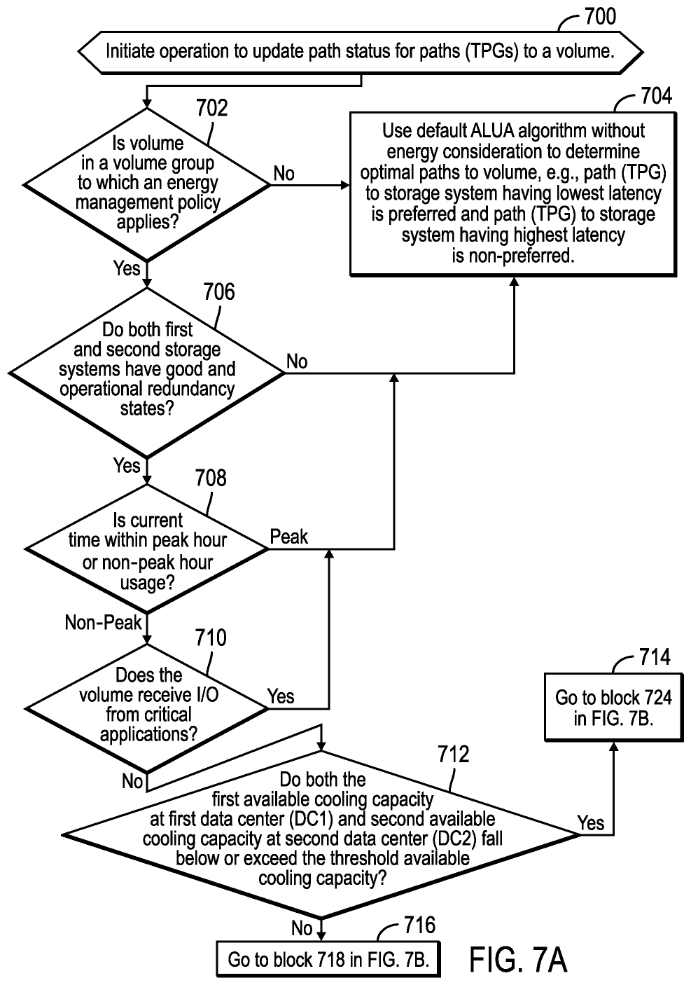

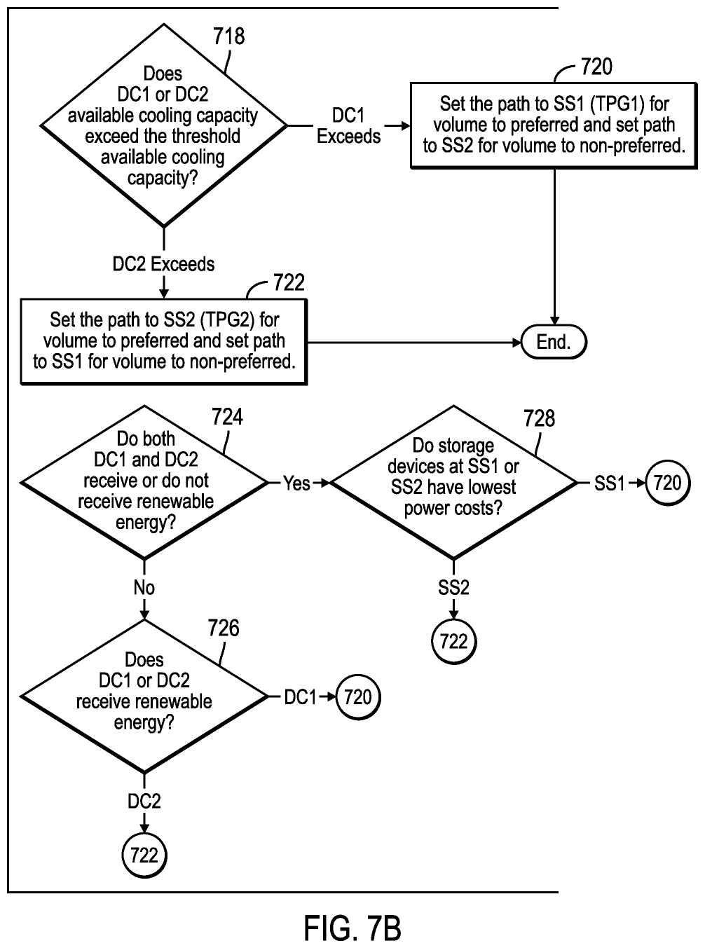

With the embodiment of FIG. 6, the storage systems 200₁ and 200₂ are configured in a failover/failback relationship providing access to the same volumes. Further, the storage systems 200₁ and 200₂ monitor how much cooling headroom there is in the data centers 218₁, 218₂ to take on additional thermal load, which indicates the current resiliency of the data centers 218₁, 218₂ to handle temperature increases, and to measure how much of the power mix of the data center 218₁, 218₂ is sourced from renewable energy. This information may then be used in FIGS. 7a and 7b to determine whether the data centers 218₁, 218₂ satisfy certain energy criteria, such as data center having sufficient available cooling capacity, use of renewable energy, and lower power costs of the storage devices implementing the volumes.

FIGS. 7a and 7b illustrate an embodiment of operations performed by the path manager 230 in the first 200₁ and second 200₂ storage systems to set the preferred path information in the port group information 300₁, 300₂ based on current energy, performance and operational conditions. The operations of FIGS. 7a, 7b are done for one volume. However, the operations may be performed for all volumes 204 in the storage 206. Upon initiating (at block 700) an operation to update the path status for a volume 204ᵢ, or port group information 300ᵢ, in a storage system 200ᵢ, a determination is made (at block 702) whether the volume 204ᵢ is in a volume group to which an energy management policy applies. If (at block 702) the volume 204ᵢ is in a volume group to which an energy management policy applies, the path manager 230 determines (at block 706) whether storage system 200ᵢ and a paired storage system 200j have a good and operational redundancy state. If (at block 706) the operational redundancy state is good and operational, then the path manager 230 determines (at block 708) whether a current time is within a peak hour or non-peak hour usage, where during peak hour usage there is heightened levels of I/O traffic. If (at block 708) the current time is within non-peak hour usage, then a determination is made (at block 710) whether the volume 204ᵢ is receiving I/O from critical applications. If (at block 710) non-critical I/O is primarily directed to volume 204ᵢ, then control proceeds to block 712 et seq. to use energy management policies to determine the preferred path.

If any of the conditions checked a blocks 702, 706, 708, and 710 indicate that energy considerations should not control whether a path (TPG) to the volume 204ᵢ is designated as preferred or non-preferred, then the path manager 230 uses (at block 704) a default Asymmetric Logical Unit Access (ALUA) algorithm without energy consideration to determine optimal paths to the volume 204i, e.g., path (TPG) to storage system having lowest latency is preferred and path (TPG) to storage system having highest latency is non-preferred.

If environmental energy factors are applicable to whether a path is preferred or non-preferred, then the path manager 230 determines (at block 712) whether a first available cooling capacity 506₁ (a first value of the energy attribute of available cooling capacity) at the first data center (DC1) 218₁ and second available cooling capacity 506₂ (a second value of the energy attribute of available cooling capacity) at the second data center (DC2) 218₂ either fall below or exceed a threshold available cooling capacity. If (at block 712) both first and second available cooling capacities (values) either fall below or exceed the threshold available cooling capacity, then the operational capacity of the cooling systems 226₁, 226₂ at the data centers 218₁, 218₂ is not dispositive, and control proceeds (at block 714) to block 724 in FIG. 7b to consider values for a next energy attribute to determine paths in target path groups as preferred or non-preferred.

However, if (at block 712) the operational capacity of the cooling systems 226₁, 226₂ at the data centers 218₁, 218₂ is dispositive, then control proceeds (at block 716) to block 718 in FIG. 7b to determine whether the first data center (DC1) 218₁ or the second data center (DC2) 218₂ have available cooling capacity 406 that exceeds the threshold. If (at block 718) the first data center 218₁ has available cooling capacity (value) exceeding the threshold, then the path manager 230 sets (at block 720) the TPG1 state 306₁ for the first storage system (SS1) 200₁ for volume 204ᵢ to the preferred path and sets the TPG2 state 306₂ for the second storage system (SS2) 200₂ to non-preferred. If (at block 718) the second data center 218₂ has an available cooling capacity value exceeding the threshold, then the path manager 230 sets (at block 722) the TPG1 state 306₁ for the first storage system (SS1) 200₁ for volume 204i to non-preferred and sets the TPG2 state 306₂ for the second storage system (SS2) 200₂ to preferred. Control ends at this point as the path state is set. The storage system 200ᵢ may return the updated path state information 306₁, 306₂ to the host 100 when the host 100 queries the storage system 200i for this information. Alternatively, after updating path state information 306i, the storage system 200ᵢ may notify the hosts 100 of the updated path status if it has changed so the hosts 100 may immediately start transmitting I/O requests on the preferred or optimal path, such as to a storage system at a data center 218 that has sufficient cooling capacity and, hence, lower risk of overheating.

If (at block 724) both data centers 218₁, 218₂ receive or do not receive local renewable energy 216, where the information of whether renewable energy is received is the value of the energy attribute renewable energy, then renewable energy is not dispositive for determining a preferred path and control proceeds to block 728 to consider values for a next energy attribute concerning power cost of storage devices at the storages 206₁, 206₂ for the first 200₁ and second 200₂ storage systems, respectively. If (at block 724) only one of the data centers 218₁, 218₂ receive renewable energy and if (at block 726) the first data center 218₁ receives renewable energy and the second data center 218₂ does not, then control proceeds to block 720 to set the TPG1 port group state 306₁ for the first storage system 200₁ as the preferred path and the TPG2 port group state 306₂ for the second storage system 200₂ to non-preferred. Otherwise, if (at block 726) the second data center 218₂ receives renewable energy, then control proceeds to block 722 to set the TPG2 port group state 306₂ for the second storage system 200₂ as the preferred path and the TPG1 port group state 306₁ for the first storage system 200₁ to non-preferred.

If (at block 728) the storage devices for the volume 204ᵢ at the first storage system 200₁ have a lower power cost 510₁ (first value of energy attribute of power cost) than the power cost 510₂ (second value of energy attribute of power cost) for the storage devices implementing the volume 204ᵢ at the second storage system 200₂, then control proceeds to block 720 to set the TPG1 port group state 306₁ for the first storage system 200₁ as the preferred path and the TPG2 port group state 306₂ for the second storage system 200₂ to non-preferred. If (at block 728) the storage devices for the volume 204ᵢ at the second storage system 200₂ have a lower power cost 510₂ than the power cost 510₁ for the storage devices implementing the volume 204ᵢ at the first storage system 200₁, then control proceeds to block 722 to set the TPG2 port group state 306₂ for the second storage system 200₂ as the preferred path and the TPG1 port group state 306₁ for the first storage system 200₁ to non-preferred.

With the embodiment of operations of FIGS. 7a, 7b a series of conditions first must be satisfied to determine whether energy considerations should determine preferred paths over performance issues, such as latency. Before values for energy attributes are considered to determine the preferred path, the volume for which the consideration is made must be in a volume group to which energy management policies apply, have good operational redundancy, that the consideration is not done during peak hours, and that the volume is not used by mission critical applications. If these considerations are met, then energy criteria may be considered to determine the preferred path to a storage system satisfying energy criteria, such the storage system is in a data center having sufficient cooling headroom, the data center renewable energy, or the storage system has storage devices with a lower power cost profile. Using energy considerations when appropriate reduces energy usage and helps lower the carbon footprint of the data center and computing operations.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods of blocks 210 and 230 to determine values for energy attributes and preferred paths to a volume maintained in redundant storage systems based on the energy attributes 5 in determining preferred paths. In addition, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and blocks 210 and 230, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

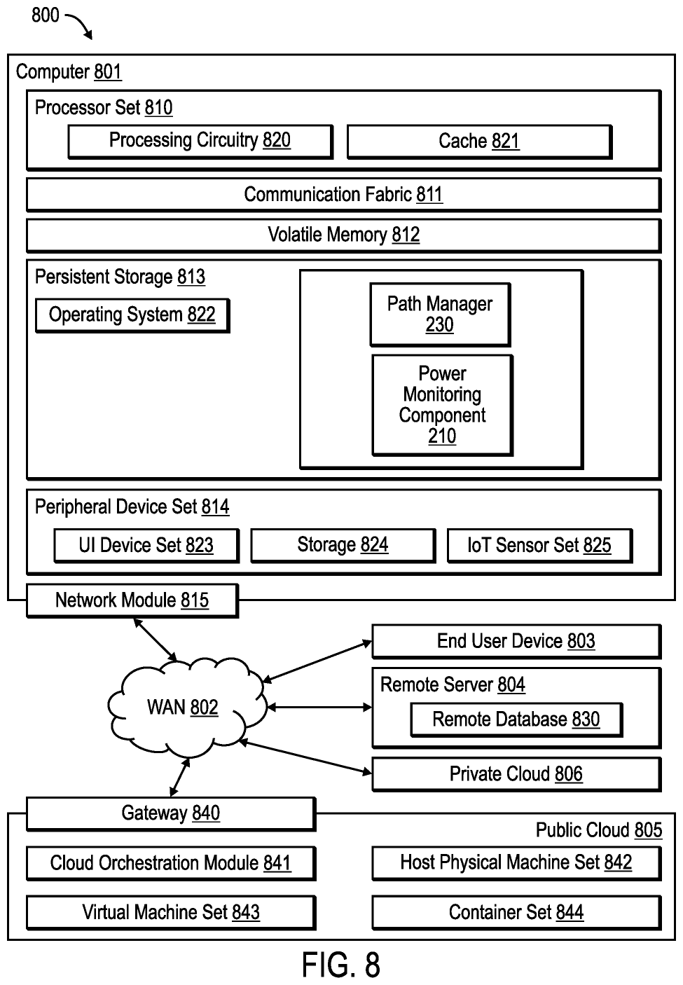

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated. The host 100, quorum witness 110, and storage systems 200₁, 200₂ may implement the components of computer 801.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in blocks 210 and 230 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in blocks 210 and 230 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 115 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be the host 100 or a client device, such as thin client, heavy client, mainframe computer, desktop computer and so on.

REMOTE SERVER 804 is any computer system that serves at least some data and/or functionality to computer 801. For instance, if computer 801 comprises the first storage system 200₁, then remote server 804 may comprise second storage 200₂, and vice versa. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The letter designators, such as i and j are used herein to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for providing path information for paths from a host to a first storage system and a second storage system, the computer program product comprising a computer readable storage medium having computer readable program code embodied in the first storage system that is executable to perform operations, the operations comprising:
determining whether a first value of an energy attribute for the first storage system satisfies an energy criteria and whether a second value of the energy attribute for the second storage system satisfies the energy criteria;
indicating first paths to the first storage system as preferred and second paths to the second storage system as non-preferred in response to determining that the first value satisfies the energy criteria and the second value does not satisfy the energy criteria; and
indicating the first paths to the first storage system as non-preferred and the second paths to the second storage system as preferred in response to determining that the first value does not satisfy the energy criteria and the second value satisfies the energy criteria.

2. The computer program product of claim 1, wherein the operations further comprise:
using path latency for the first paths and the second paths to determine which of the first paths and the second paths to indicate as preferred and non-preferred in response to determining that either one of that both the first value and the second value satisfies the energy criteria and that both the first value and the second value do not satisfy the energy criteria.

3. The computer program product of claim 1, wherein the energy attribute indicates an available cooling capacity, wherein the first value indicates a first available cooling capacity at a first data center at which the first storage system is located, wherein the second value indicates a second available cooling capacity at a second data center at which the second storage system is located, wherein the energy criteria comprises a threshold available cooling capacity, wherein the first available cooling capacity and the second available cooling capacity satisfy the energy criteria in response to exceeding the threshold available cooling capacity, and wherein the first available cooling capacity and the second available cooling capacity do not satisfy the energy criteria in response to not exceeding the threshold available cooling capacity.

4. The computer program product of claim 3, wherein the energy attribute of available cooling capacity indicates unused cooling capacity, wherein the operations further comprise:
receiving information from a first cooling system at the first data center indicating the first available cooling capacity; and
receiving information from a second cooling system at the second data center indicating the second available cooling capacity.

5. The computer program product of claim 1, wherein the energy attribute comprises renewable energy, wherein the first value satisfies the energy criteria when a first data center having the first storage system receives renewable energy, wherein the second value satisfies the energy criteria when a second data center having the second storage system receives renewable energy, wherein the first value does not satisfy the energy criteria when the first data center does not receive renewable energy, and wherein the second value does not satisfy the energy criteria when the second data center does not receive renewable energy.

6. The computer program product of claim 1, wherein the operations further comprise:
determining whether a volume is read or write intensive, wherein in response to the volume being read intensive, the energy attribute indicates an estimated energy usage of storage devices, wherein the first value comprises a first estimated energy usage of first storage devices at the first storage system and the second value comprises a second estimated energy usage of second storage devices at the second storage system, wherein the first estimated energy usage satisfies the energy criteria and the second estimated energy usage does not satisfy the energy criteria in response to the second estimated energy usage exceeding the first estimated energy usage, and wherein the second estimated energy usage satisfies the energy criteria and the first estimated energy usage does not satisfy the energy criteria in response to the first estimated energy usage exceeding the second estimated energy usage.

7. The computer program product of claim 1, wherein the determining whether the first and the second values of the energy attribute satisfy the energy criteria and indicating one the first paths and the second paths as preferred are performed during non-peak hour usage periods, wherein the operations further comprise during peak hour usage periods:
indicating the first paths as preferred in response to determining the first paths have lower latency than the second paths; and
indicating the second paths as preferred in response to determining the second paths have lower latency than the first paths.

8. The computer program product of claim 1, wherein the operations further comprise:
determining whether a volume is indicated as critical, wherein the volume is indicated as critical when the volume receives Input/Output requests from critical applications, wherein the determining whether the first and the second values of the energy attribute satisfies the energy criteria to determine whether to indicate the first paths and the second paths as preferred or non-preferred is only performed in response to determining that the volume is not-critical.

9. The computer program product of claim 1, wherein the operations further comprise:
organizing volumes accessible through the first storage system and the second storage system in first volume groups and second volume groups, wherein an energy management policy is applied to the first volume group including the volume, wherein the determining whether the first and the second values of the energy attribute satisfy the energy criteria to determine whether to indicate paths and indicating the first paths or the second paths as preferred are performed for volumes in the first volume group; and
considering latency to determine whether to indicate paths to the volumes in the second volume group as preferred or non-preferred.

10. The computer program product of claim 1, wherein the energy attribute comprises a first energy attribute and the energy criteria comprises a first energy criteria, wherein the operations further comprise:
in response to determining that the first and the second values of the first energy attribute satisfy the first energy criteria, determining whether a first value of a second energy attribute for the first storage system and a second value of the second energy attribute for the second storage system satisfy a second energy criteria to determine whether to indicate the first paths and the second paths as preferred or non-preferred; and
in response to determining that the first and the second values of the second energy attribute satisfy the second energy criteria, determining whether a first value of a third energy attribute for the first storage system and a second value of the third energy attribute for the second storage system satisfy a third energy criteria to determine whether to indicate the first paths and the second paths as preferred or non-preferred.

11. A system comprising a first storage system and a second storage system for providing path information for paths from a host to the first storage system and the second storage system, comprising:
a processor at the first storage system; and
a computer readable storage medium having computer readable program code embodied in the first storage system that when executed by the processor performs operations, the operations comprising:
determining whether a first value of an energy attribute for the first storage system satisfies an energy criteria and whether a second value of the energy attribute for the second storage system satisfies the energy criteria;
indicating first paths to the first storage system as preferred and second paths to the second storage system as non-preferred in response to determining that the first value satisfies the energy criteria and the second value does not satisfy the energy criteria; and
indicating the first paths to the first storage system as non-preferred and the second paths to the second storage system as preferred in response to determining that the first value does not satisfy the energy criteria and the second value satisfies the energy criteria.

12. The system of claim 11, wherein the operations further comprise:
using path latency for the first paths and the second paths to determine which of the first paths and the second paths to indicate as preferred and non-preferred in response to determining that either one of that both the first value and the second value satisfies the energy criteria and that both the first value and the second value do not satisfy the energy criteria.

13. The system of claim 11, wherein the energy attribute indicates an available cooling capacity, wherein the first value indicates a first available cooling capacity at a first data center at which the first storage system is located, wherein the second value indicates a second available cooling capacity at a second data center at which the second storage system is located, wherein the energy criteria comprises a threshold available cooling capacity, wherein the first available cooling capacity and the second available cooling capacity satisfy the energy criteria in response to exceeding the threshold available cooling capacity, and wherein the first available cooling capacity and the second available cooling capacity do not satisfy the energy criteria in response to not exceeding the threshold available cooling capacity.

14. The system of claim 11, wherein the energy attribute comprises renewable energy, wherein the first value satisfies the energy criteria when a first data center having the first storage system receives renewable energy, wherein the second value satisfies the energy criteria when a second data center having the second storage system receives renewable energy, wherein the first value does not satisfy the energy criteria when the first data center does not receive renewable energy, and wherein the second value does not satisfy the energy criteria when the second data center does not receive renewable energy.

15. The system of claim 11, wherein the operations further comprise:
determining whether a volume is read or write intensive, wherein in response to the volume being read intensive, the energy attribute indicates an estimated energy usage of storage devices, wherein the first value comprises a first estimated energy usage of first storage devices at the first storage system and the second value comprises a second estimated energy usage of second storage devices at the second storage system, wherein the first estimated energy usage satisfies the energy criteria and the second estimated energy usage does not satisfy the energy criteria in response to the second estimated energy usage exceeding the first estimated energy usage, and wherein the second estimated energy usage satisfies the energy criteria and the first estimated energy usage does not satisfy the energy criteria in response to the first estimated energy usage exceeding the second estimated energy usage.

16. A method for providing path information for paths from a host to a first storage system and a second storage system, comprising:
determining whether a first value of an energy attribute for the first storage system satisfies an energy criteria and whether a second value of the energy attribute for the second storage system satisfies the energy criteria;
indicating first paths to the first storage system as preferred and second paths to the second storage system as non-preferred in response to determining that the first value satisfies the energy criteria and the second value does not satisfy the energy criteria; and
indicating the first paths to the first storage system as non-preferred and the second paths to the second storage system as preferred in response to determining that the first value does not satisfy the energy criteria and the second value satisfies the energy criteria.

17. The method of claim 16, further comprising:
using path latency for the first paths and the second paths to determine which of the first paths and the second paths to indicate as preferred and non-preferred in response to determining that either one of that both the first value and the second value satisfies the energy criteria and that both the first value and the second value do not satisfy the energy criteria.

18. The method of claim 16, wherein the energy attribute indicates an available cooling capacity, wherein the first value indicates a first available cooling capacity at a first data center at which the first storage system is located, wherein the second value indicates a second available cooling capacity at a second data center at which the second storage system is located, wherein the energy criteria comprises a threshold available cooling capacity, wherein the first available cooling capacity and the second available cooling capacity satisfy the energy criteria in response to exceeding the threshold available cooling capacity, and wherein the first available cooling capacity and the second available cooling capacity do not satisfy the energy criteria in response to not exceeding the threshold available cooling capacity.

19. The method of claim 16, wherein the energy attribute comprises renewable energy, wherein the first value satisfies the energy criteria when a first data center having the first storage system receives renewable energy, wherein the second value satisfies the energy criteria when a second data center having the second storage system receives renewable energy, wherein the first value does not satisfy the energy criteria when the first data center does not receive renewable energy, and wherein the second value does not satisfy the energy criteria when the second data center does not receive renewable energy.

20. The method of claim 16, further comprising:
determining whether a volume is read or write intensive, wherein in response to the volume being read intensive, the energy attribute indicates an estimated energy usage of storage devices, wherein the first value comprises a first estimated energy usage of first storage devices at the first storage system and the second value comprises a second estimated energy usage of second storage devices at the second storage system, wherein the first estimated energy usage satisfies the energy criteria and the second estimated energy usage does not satisfy the energy criteria in response to the second estimated energy usage exceeding the first estimated energy usage, and wherein the second estimated energy usage satisfies the energy criteria and the first estimated energy usage does not satisfy the energy criteria in response to the first estimated energy usage exceeding the second estimated energy usage.
